(19) United States
(12) Patent Application Publication
(10) Pub. No.: US 2005/0135575 A1
(43) Pub. Date: Jun. 23, 2005

(54) Tuning an interactive voise response system

(75) Inventors: Stephen J. Haskey, Eastleigh (GB); David S. Renshaw, Winchester (GB)

Correspondence Address: IBM Corp;IP Law Dept T81/503, 3039 Cornwallis Road, PO Box 12195, Research Triangle Park, NC, 27709-2195, US

(73) Assignee: International Business Machines Corporation, Armonk, NY (US)

(21) Appl. No.: 10/957,561

(22) Filed: Oct. 1, 2004

(30) Foreign Application Priority Data
Dec. 19, 2003 (GB) 0329420.4

(51) Int. Cl. H04M 1/64; H04M 11/00

(52) U.S. Cl. 379/88.18

(57) ABSTRACT

An interactive voice response system (IVR) is described for processing multiple voice application instances, said system comprising: at least one resource such as a speech synthesizer or speech recognition engine; one voice application using said at least one resource; telephony software for determining that at least two instances of the same voice application will use said at least one resource simultaneously; and further telephony software for forcing the instances of the voice applications to be delayed with respect to each other whereby the risk of IVR overloading the at least one resource is reduced. The delay is forced in an active step in a voice application such as answering the application or playing a prompt in the application only if it is determined that future resource utilization (FRM) is above resource utilization capacity (RUC).

This invention relates to a method and apparatus for tuning an interactive voice response system (IVR). In particular it relates to tuning an IVR to limit peak system resource utilisation when a large number of simultaneous calls use the same voice application and resources.

### BACKGROUND OF THE INVENTION

Enterprises and telecommunications service providers are deploying increasingly complex interactive voice response applications. These voice applications are being deployed for such things as television competitions and voting where simultaneous arrival of high call densities occur. Voice applications put extreme stress on the software infrastructure used. Furthermore, many of these new generations of voice applications use speech technologies such as speech recognition engines or speech synthesis engines which require large amounts of computational resource.

To deal with these types of scenarios during peak loading the computer systems must either have very large amounts of hardware resources to deal with the worst case or must have some way of smoothing and spreading out the resource usage. Consider an IVR deployed to take votes associated with a television program. Up until the time viewers are requested to vote, no calls are received. From the moment the telephone number is transmitted on screen, and for some considerable time afterwards, the call volumes to the IVR is extremely large. Typically in these situations a large number of calls are routed to the IVR simultaneously by the public telephone network. It is possible for a 480 line IVR to have 480 calls all arrive at the same time. The crucial problem in this scenario is the call distribution. It is expected that calls be normally distributed, arriving at ‘random’ times and each requiring or executing computationally expensive resources at hopefully different times. However, with the voting scenario nearly all the calls start at the same time and all require a computationally expensive resource at the same instant. This requirement happens regardless of the resource duty cycle (the percentage of time the resource is used). Furthermore, in all the calls, users respond to identical prompts and many responses will happen at the same time and subsequent simultaneous peaks of activity will be apparent throughout the duration of the call. Prior art load balancing solutions are applied at the time of overload. Furthermore prior art load balancing solutions do not consider the special case of simultaneous voice applications.

### SUMMARY OF INVENTION

According to a first aspect of the present invention there is provided an interactive voice response system (IVR) for processing multiple voice application instances, said system comprising: at least one resource; one voice application using said at least one resource; means for determining that at least two instances of the same voice application will use said at least one resource simultaneously; and means for forcing the instances of the applications to be delayed with respect to each other; whereby the risk of IVR overloading the at least one resource is reduced.

This solution is a mechanism for affecting more efficient resource usage during peak loading by forcing staggering among simultaneous resource requests before the requests are incident on the resource. Such a mechanism is directed towards prevention of overloaded resources rather than cure.

Preferably, the forced delay is performed if it is determined that future resource utilization (FRM) is above resource utilization capacity (RUC). This condition allows maximum throughput when the IVR can handle simultaneous resource use without overload.

In one example, the system receives simultaneous calls from users for the same voice application. A prior art solution would answer all the calls at the same time if it had enough telephony resource. However, as the voice application progresses, the system might find that the speech resource becomes overloaded and the users notice a reduced or substandard performance. If the prior art applies load balancing at the instance of overload, reduced performance occurs because the voice application is already in progress. Advantageously the preferred embodiment introduces a stepped delay before a resource becomes overloaded. Most advantageously the preferred embodiment introduces a stepped delay in answering each of simultaneous calls so that the speech resource never becomes overloaded. While the telephone calls are in “alerting” state i.e. the caller is hearing the ringing tone but the call has not yet been connected to the voice response system, the load on the system resources is negligible. Normally the provider of a system such as this will require it to guarantee to speak to the caller within a set period of time after answering the call, typically 1 to 2 seconds. If a call is answered but the caller hears nothing for 5 to 10 seconds (dead air), this sounds to the caller like an unresponsive system. If the system allows the ringing tone for 5 to 10 seconds before answering and then the system speaks within 1 second of answering, it will seem that the system is responsive but busy. Therefore the embodiment seeks to exploit this difference in perception by staggering the rate at which new calls for the same application are answered to reduce the peak resource usage of the system.

In another example the system uses a different prompt playing time for a corresponding prompt in each of the simultaneous applications.

### DESCRIPTION OF DRAWINGS

In order to promote a fuller understanding of this and other aspects of the present invention, an embodiment of the invention will now be described, by means of example only, with reference to the accompanying drawings in which:

FIG. 1 is a schematic representation of an IVR according to the preferred embodiment;

FIG. 2 is a more detailed schematic representation of telephony software of the preferred embodiment;

FIG. 3 is flow diagram of the process of the preferred embodiment;

FIGS. 4A and 4B are timeline representations of calls and the accompanying demands on the system resources; and

FIGS. 5A and 5B are timeline representations of call activity pattern.

### DESCRIPTION OF THE EMBODIMENTS

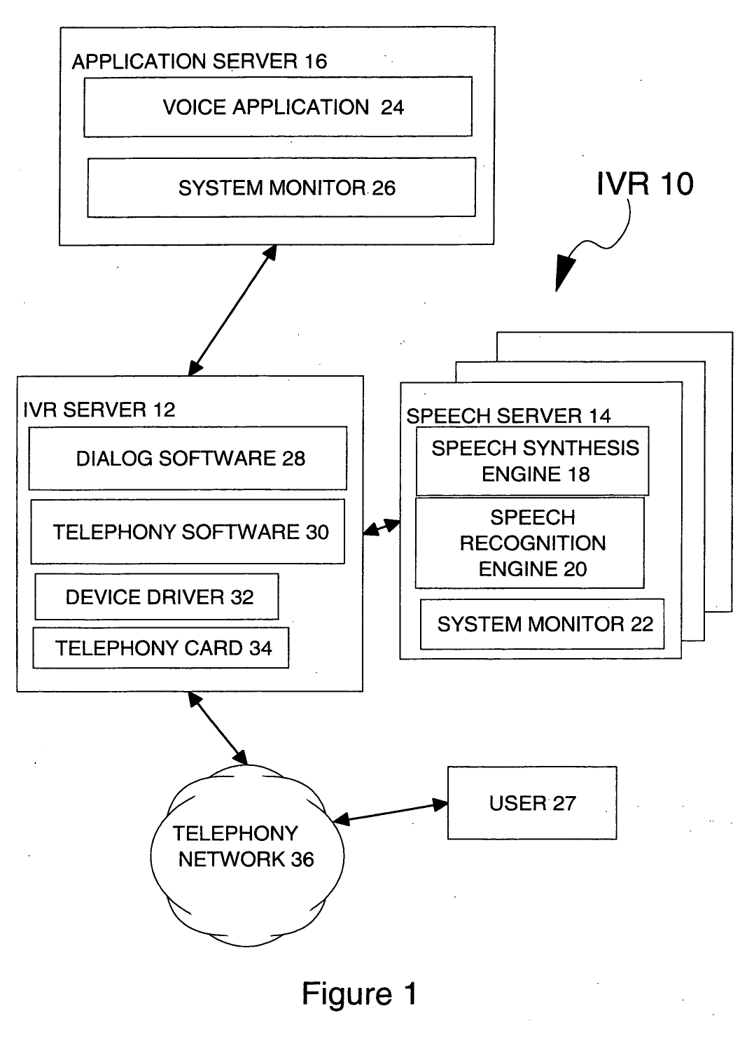

Referring to FIG. 1 there is shown an interactive voice response system (IVR) 10 which is the preferred embodiment of the invention. The IVR 10 comprises: an IVR server 12; a speech server 14; and an application server 16.

The speech server 14 comprises: a speech synthesis engine 18; a speech recognition engine 20 and a system monitor 22. The system monitor 22 reports on the resource utilization of the speech synthesis engine 18 and the speech recognition engine 20. The speech synthesis engine 18 and speech recognition engine 20 are referred to collectively as speech resources.

The application server 16 comprises: a voice application 24 and a system monitor 26. The voice application 24 defines interactions between the IVR server 12, the user and the speech resources.

The IVR server 12 comprises: dialog software 28; telephony software 30; a device driver 32; and a telephony card 34. The dialog software 28 performs the application functions of the IVR 10 and handles the interaction between user 27 and the voice application. The telephony software 30 performs lower level telephony and speech functions required by the voice application 24. The device driver 32 and telephony card 34 are the interface to the user 27 through telephony network 36.

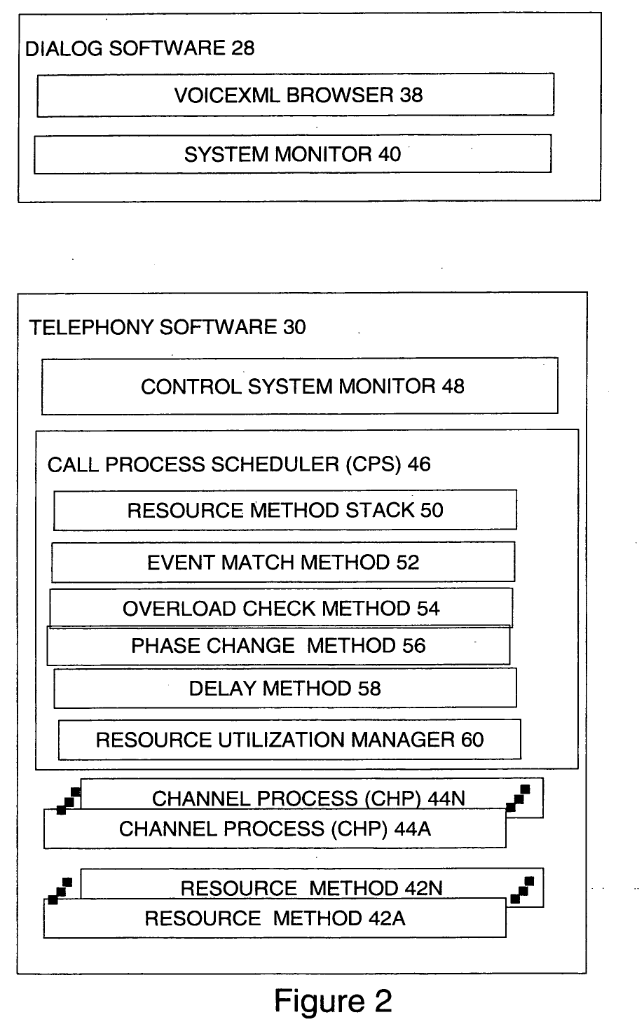

Referring to FIG. 2, the dialog software 28 comprises a VoiceXML browser 38 and system monitor 40. The VoiceXML browser 38 interprets VoiceXML tags in the voice application 24 and issues requests to telephony software 30 to operate on a call on a telephony channel. Such requests include such play prompt and recognise voice data which are forwarded to the speech resource.

The telephony software 30 comprises: call methods 42A . . . 42N; a call process scheduler (CPS) 46; and a control system monitor 48. The call methods 42A . . . 44N interface with the telephony card 34 and the speech resource and include a play prompt call method on a voice channel and a recognise voice data call method from a voice channel. The CPS 46 opens a channel process (CHP) for each call between the IVR server 12 and a user 27. Call functions are performed with respect to each open CHP.

A system monitor is located in each of the dialog software 28; telephony software 30; speech server 14; and the application server 16. Each system monitor collects information from its environment and sends it to control system monitor 48. The information collected comprises: CPU usage of the software or server; the amount of free memory available; and the paging rate of the software or server plus component specific data. The telephony software information additionally comprises: the number of telephone channels currently in use and the available DSP (Digital Signal Processor) resources available on each adapter cards. The dialog software information additionally comprises: the number of VoiceXML browsers in use; the number of browsers idle; and the average storage usage per browser. The system monitors deliver their information at predefined intervals. The control system monitor uses the collected information to determine a resource utilization parameter for each resource in terms of how much of the capacity of the resource is being used at that instant.

The CPS 46 comprises: a resource method stack 50; an event match method 52; a overload check method 54; a phase change method 56; a delay method 58; and a resource utilization manager 60.

All calls to resource methods 42A . . . 42N are pushed onto the resource method stack 50 in a first-in first-out order before execution. The resource method stack 50 triggers the event match method 52 to check a resource method call as it passes through the resource method stack 50.

The event match method 52 looks for a call to an ‘open CHP’ resource method. An ‘open CHP’ resource method contains the name of the voice application to be associated with the CHP. The event match method 52 determines when at least two instances of the same voice application are opened simultaneously. Simultaneously in this embodiment means within a one second period but in other embodiments can be as low as a tenth of a second or up to ten seconds. The event match method 52 counts the number of calls to the ‘open CHP’ resource method for each application within the one second period. If there are more than two calls to the ‘open CHP’ resource method then the event match method 52 will identify the associated CHPs as simultaneous CHPs.

The IVR server can support simultaneous voice application instances but resource overload can occur and slow the resource efficiency. Determination of the overload condition takes into account application resource utilization (ARU), the number of simultaneous applications (N), present resource utilization (PRU) and resource utilization capacity (RUC).

The application resource utilization (ARU) is coded into the application itself expressed as a maximum percentage of a unit of that resource. For instance, a voice application that uses a maximum 10% of a speech recognition engine per second has the value of 10% coded into the voice application in respect of the speech recognition engine. The application resource utilization (ARU) for each resource in each VoiceXML application is calculated in terms of the highest use over a minute. For instance, the application may claim 10% of a speech recognition engine for a second at the peak of its activity. If 10 applications are being used simultaneously then the speech resource will use a maximum of 100% of a single resource but only 50% of the total resource when there are two speech recognition engines.

The future resource utilization (FRU) is an estimate of the maximum resource utilization that will occur if the voice applications are executed simultaneously. It is estimated by summing the total application resource utilization (TARU) with the present resource utilization (PRU). The total application resource utilization is the application resource utilization (ARU) multiplied by the number of simultaneous applications (N). The present resource utilization (PRU) is acquired from the system monitor for that resource using the control system monitor.

The resource utilization capacity (RUC) is a function of the number of units of resource available (M) and a threshold resource utilization (TRU). The overload check method acquires both the number of available units and the threshold resource utilization (TRU) from the control system monitor. In the preferred embodiment the function is a product of the M and RUC but another function may be discovered by trial and error.

If the future resource utilization (FRU) is more than the resource utilization capacity (RUC), as determined by the overload check method, then the phase change method is called. Otherwise the CHPs are allowed to process the voice application simultaneously.

Expressed in code form:

If FRU>RUC then call the phase change method; or
If TARU+PRU>M×TRU then call the phase change method; or
If ARU×N+PRU>M×TRU then call the phase change method.

The phase change method forces one instance of the application to be delayed with respect to the other whereby the risk of the two voice application instances demanding simultaneous use of the same resource in subsequent steps of the application are reduced. The phase change method acquires a list of the CHPs used by the simultaneous open CHP method calls. Then the phase change method runs through each CHP and calls the delay method with different delay periods. The first CHP is ignored, the second CHP is delayed by a predefined amount, the third CHP is delayed by twice the predetermined amount. Each subsequent CHP is delayed by a subsequent extra predetermined delay. The delays are created by a call to delay CHP method. The predetermined amount is a function of resource utilization overload (RUO) and a starting delay. The resource utilization overload (RUO) is the future resource utilization (FRU) minus the resource utilization capacity (RUC). For instance, if a thousand calls simultaneously open the same voice application and the resource utilization overload (RUO) is 10% then a starting delay in answering each call is introduced (say 1 millisecond). If the resource utilization overload (RUO) is predicted to be 20% then the delay can be doubled (two millisecond).

A CHP delay is created by locating a call function in a call function stack associated to the CHP and extending the call function in some way. Each type of call function may be delayed in a unique way. Some call functions have a timing parameter which is altered. For prompt play out call functions, the prompt is changed to increase its playing out length. In the case of call alerting the parameter controlling the time taken to answer the call after the alert is changed. The delayed call function may occur prior to the simultaneous method call or can be the simultaneous method call function itself. In another embodiment a delay routine cause the CHP to become idle for a preset time between call functions.

If no resource utilization data exists in an application then a resource utilization method is called to create it. Resource utilization data for each VoiceXML application is calculated and embedded into each voice application using XML code. A CPS usage pattern relates a service, identified by the called number, to the pattern of usage of the major resources of the system. For example a call to the service identified by the number 555-1234 results in a dialogue between the system and the caller. Initially the system plays a pre-recorded audio prompt welcoming the caller and asking him for his account number, this prompt takes “a” seconds to play. To collect the callers account number the system uses a speech recognition engine and the processes typically takes “x” seconds. The dialogue then proceeds to solicit the users PIN code by playing another prompt which takes “b” seconds. Again speech recognition is used to capture the caller's response and this takes “y” seconds. Once the system has the callers account number and PIN code a request is made to the application server to retrieve a VoiceXML document containing a dialog that informs the caller of his current bank balance. The request takes “n” seconds. Once the document is received the account balance is announce to the user using a Text-To-Speech (TTS) engine to synthesise the data, this takes “z” seconds. After announcing the data the system hangs up. By way of example, the resource utilization data for this application expressed in an XML data format looks like:

<ServiceId>

555-1234
<Pattern>

<Prompt>a+b</Prompt>
<Reco>x+y</Reco>
<Server>n</Server>
<TTS>z</TTS>

</Pattern>

</ServiceId>

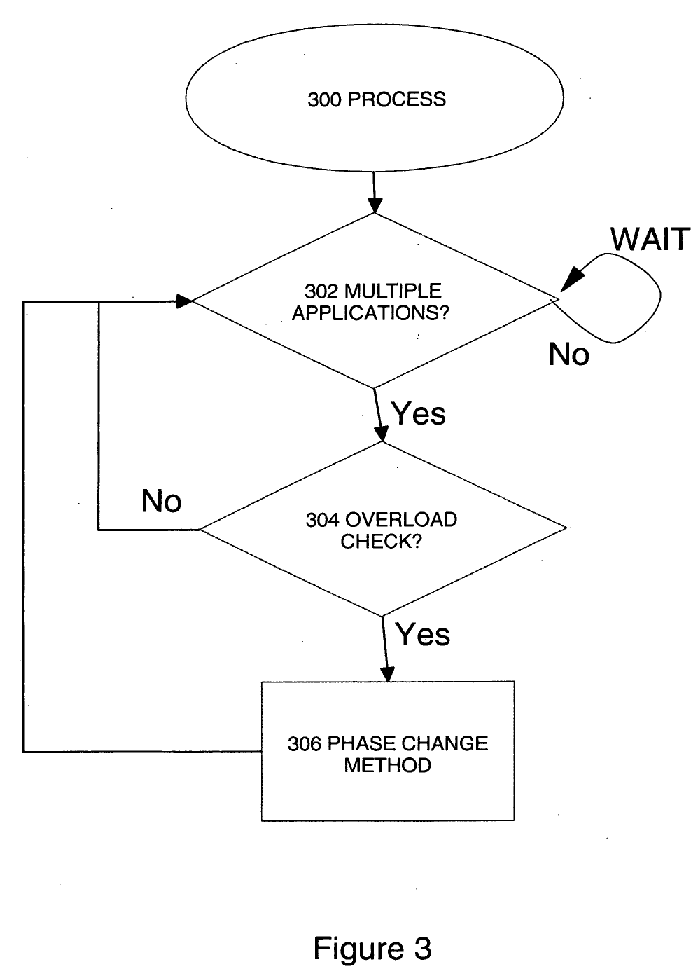

Referring to FIG. 3 there is shown through process 300 of the embodiment.

Step 302, the event match method 52 scans the resource method stack 50 for more than one request to open CHPs for the same application within the same period (for example a 1 sec period) and then passes control to the overload check method 54.

Step 304, the overload check method 54 estimates the total resource utilization for each resource used by the application and compares this with the available resource collected by the system monitors. If the comparison for any resource is more than the threshold then the process control passes to the phase change method 56. If the comparison for any resource is less than the threshold then the process control goes back to the waiting state 302 for multiple application instances to be opened.

Step 306, the phase change method forces each of the simultaneous applications to be delayed with respect to each preceding application. The process returns to the waiting state of step 302.

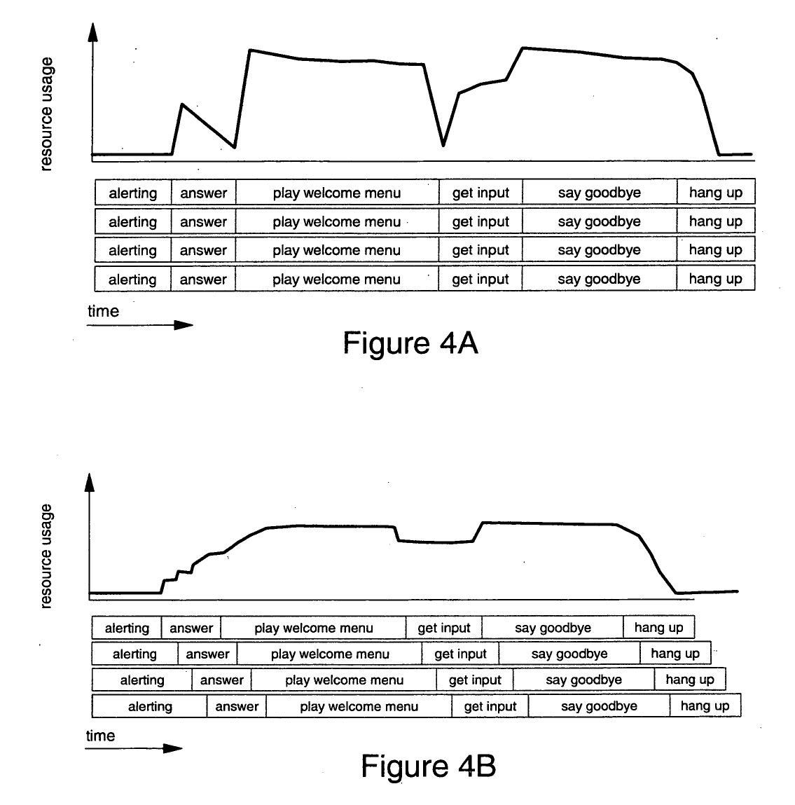

Referring to FIG. 4A, there is represented a timeline of calls and the accompanying demands on the system resources. For each action during the call there is a fixed system resource requirement which is the same for each call. After being delivered in alerting state to the voice response system. Consequently, the requirements for system resources tend to peak at points throughout the calls where actions align. If the system does not have adequate resource to meet these demands the audio quality heard by the caller or the responsiveness of the system will suffer. If the system were to stagger the rate at which it took the calls initially then the peak resource usage could be reduced but the caller would hear ‘dead air’ and the system would seem less responsive. The following diagram shows the effective change in system resource usage through the insertion of delays.

Referring to FIG. 4B, while the staggering of call arrival can improve the resource usage of the system to some extent, a more dramatic effect can be obtained when the same concept of delay insertion is used in systems that use speech technologies such as speech recognition or text-to-speech. These technologies are frequently extremely expensive in computational resource usage on both the client side, when streaming audio and doing speech detection, and on the server side where these technologies tend to reside. Staggering the active part of the calls (e.g. the alerting part), to reduce the simultaneous call alignment can also reduce the number of speech technology engines needed to support the system.

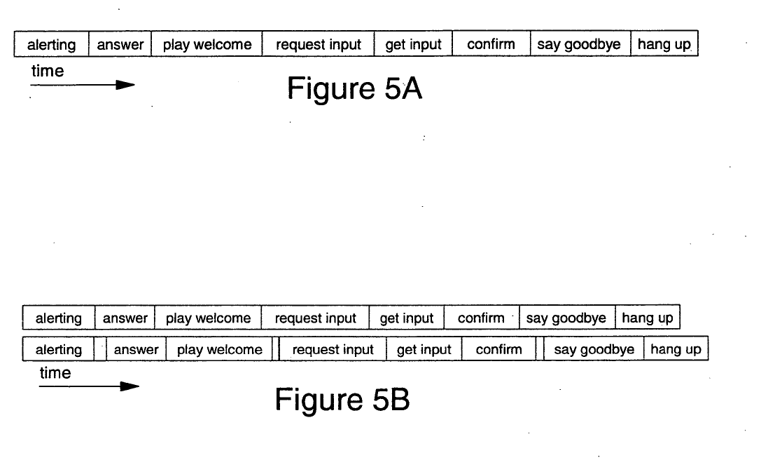

By inserting small delays in the active methods further resource usage savings can be obtained. Consider the call activity pattern of FIG. 5A. In this call there are a number of places where small delays can be introduced by the system to allow it to balance the load. As discussed already, the call can be left in alerting state for a number of seconds without greatly impacting the callers perception of the systems repressiveness. Also there are points between phrases spoken to the caller where smaller delays can be inserted: between the welcome prompt and the request for input, and between the input confirmation and the goodbye message. These delays must be short, in the region of 1/2 to 1 second to avoid disrupting the flow of output to the caller. Such delays, inserted in an active part of the call (such as the prompting) have less disrupting effect on the user than in a non-active part such as a wait to answer a call.

Referring to FIG. 5B, smaller delays are added and the resource utilisation of the speech technologies is changed by delaying the allocation of expensive speech recognition technologies. While the effect of adding delays to a single call may be small, and imperceptible to the caller, the effect of dynamically adding these small delays across a system servicing hundreds of calls can substantially modify the resource usage patterns.

In the preferred embodiment the IVR server; application server; and speech server are deployed on separate platforms connected by a network. Using multiple network connections allows the system to be resilient to failure and increases the total network bandwidth available. The exact network configuration used depends on the level of failure resilience required and the total processing power required to meet the call load of the solution. However, alternative embodiments may combine two or more servers on one platform.

In the preferred embodiment there is one IVR server. However the number of IVR servers is dependent on the number of telephone connections that are needed for the solution. Similarly there may be one or more IVR servers running the IVR dialog software and VoiceXML browsers, the number required being dependent on the number of simultaneous telephone calls to be supported and the complexity of the VoiceXML dialogs in use.

In the preferred embodiment there is one speech recognition server. However, the number of speech servers used for any given solution is determined by the duty cycle of speech recognition engine and the speech synthesis engine and the number of simultaneous telephone calls being handled. The duty cycle is the proportion of the total duration of a call during which the recognition engines and/or synthesis engines are actually used.

In the preferred embodiment the details of the resource utilization of an application are stored within the application itself. This has the advantage of keeping all the relevant information in one place. However, the resource utilization data could also be stored in a file separate from the voice application so that the voice application does not require modification.

Generally when building a solution using these distributed technologies the system designer will not provide the maximum required capability. Providing a system that can handle the maximum load is expensive and results in a system where a large proportion of the hardware resources are under-utilised for the majority of the time. The system designer will size the solution to ensure it can cope with a target load which is generally less than the maximum and will accept that call responses will degrade if the system becomes overloaded. This embodiment reduces the likelihood of this overloading occurring and allows IVR servers to be deployed with resource tailored to the application.

1. An interactive voice response system (IVR) for processing multiple voice application instances, said system comprising:
at least one resource;
a voice application using said at least one resource;
means for determining that two instances of the voice application will use said at least one resource simultaneously; and
means for forcing a delay of one application with respect to the other, whereby a risk of IVR overloading the at least one resource is reduced.

2. A system according to claim 1 wherein the means for forcing delays an active step in a voice application.

3. A system according to claims 1 or 2 wherein the forcing of a delay is performed if it is determined that future resource utilization (FRM) is above resource utilization capacity (RUC).

4. A system according to claims 1 or 2 wherein the means for forcing introduces a delay in answering one of the applications.

5. A system according to claims 1 or 2 wherein the means for forcing uses a different prompt playing time for a corresponding prompt in each of the simultaneous applications.

6. A method for processing multiple voice application instances in an interactive voice response system (IVR), said IVR comprising at least one resource and a voice application using said at least one resource, said method comprising:
determining that two instances of the voice application will use said at least one resource simultaneously; and
forcing a delay of one application with respect to the other, whereby a risk of IVR overloading the at least one resource is reduced.

7. A method according to claim 6 wherein the step of forcing delays an active step in a voice application.

8. A method according to claims 6 or 7 wherein the step of forcing is performed if it is determined that future resource utilization (FRM) is above resource utilization capacity (RUC).

9. A method according to any one of claims 6 or 7 wherein the step of forcing introduces a delay in answering one of the voice applications.

10. A method according to claims 6 or 7 wherein the step of forcing uses a different prompt playing time for a corresponding prompt in each of the simultaneous applications.

11. A computer program product for processing one or more sets of data processing tasks for multiple voice application instances in an interactive voice response system (IVR), said IVR comprising at least one resource and a voice application using said at least one resource, said computer program product comprising computer program instructions stored on a computer-readable storage medium for, when loaded into a computer and executed, causing a computer to carry out the steps of:
determining that two instances of the voice application will use said at least one resource simultaneously; and
forcing a delay of one application with respect to the other whereby a risk of IVR overloading the at least one resource is reduced.

12. A computer program product according to claim 11 wherein the step of forcing delays an active step in a voice application.

13. A computer program product according to claims 11 or 12 wherein the step of forcing is performed if it is determined that future resource utilization (FRM) is above resource utilization capacity (RUC).

14. A computer program product according to claims 11 or 12 wherein the step of forcing introduces a delay in answering one of the voice applications.

15. A computer program product according to claims 11 or 12 wherein the step of forcing uses a different prompt playing time for a corresponding prompt in each of the simultaneous applications.
